(19) United States
(12) Patent Application Publication
(10) Pub. No.: US 2018/0107531 A1
(43) Pub. Date: Apr. 19, 2018

(54) SERVICE SERVER, USER TERMINAL AND METHOD OF 3D COLLABORATIVE PRINTING

(71) Applicant: ELECTRONICS AND TELECOMMUNICATIONS RESEARCH INSTITUTE, Daejeon (KR)

(72) Inventors: Seung-Wook LEE, Daejeon (KR); Chang-Joon PARK, Daejeon (KR); Jin-Sung CHOI, Daejeon (KR)

(21) Appl. No.: 15/725,935

(22) Filed: Oct. 5, 2017

(30) Foreign Application Priority Data
Oct. 19, 2016 (KR) 10-2016-0135798
Jun. 1, 2017 (KR) 10-2017-0068441

(51) Int. Cl. G06F 9/54; G06F 21/62; B29C 64/393; B33Y 50/02; G06F 17/30; H04L 29/06

(52) U.S. Cl. CPC G06F 9/546; G06F 21/629; H04L 63/102; B33Y 50/02; G06F 17/30165; B29C 64/393

(57) ABSTRACT

Disclosed herein are a service server, a user terminal, and a method of 3D collaborative printing providing a 3D collaborative printing service. A method of 3D collaborative printing performed by a 3D collaborative printing system includes generating, by a user terminal, control information to store the control information in a service server; generating, by the service server, a secure token to transmit the secure token to the user terminal; transmitting, by the user terminal, the secure token to one or more 3D printer; receiving, by the one or more 3D printer, the control information corresponding to the secure token from the service server using the secure token; and performing, by the one or more 3D printer, an operation corresponding to the control information.

### CROSS REFERENCE TO RELATED APPLICATION

This application claims the benefit of Korean Patent Application Nos. 10-2016-0135798, filed Oct. 19, 2016 and 10-2017-0068441, filed Jun. 1, 2017, which are hereby incorporated by reference in their entirety into this application.

### BACKGROUND OF THE INVENTION

### 1. Technical Field

The present invention relates to a technology for allowing a plurality of terminals to collaborate through a single service as a medium, and a technology for providing a 3D collaborative printing service by a user terminal, a service server, and a 3D printer.

### 2. Description of the Related Art

In the existing service, it has been mainly that a single user terminal has accessed a single internet service and used the service in a client-server environment. However, with the development of a cloud service, an Internet of Things technology, and various service devices such as a 3D printer, there is required a technology for using various service devices by using a mobile user terminal regardless of a place.

Meanwhile, a general 3D printing service searches for a 3D printer to be accessed, and selects a 3D model file from a contents file server or a contents service site of an internet site. Further, the 3D model file is downloaded and reconstructed as a file that can be 3D printed, and then the 3D printing operation is performed.

In addition, during the 3D printing operation, it monitors the over temperature of the 3D printer and running out of the filament which is the raw material of the 3D printing. Further, when the 3D printing operation is completed, the user is informed that the 3D printing is completed.

In this case, an interface receiving contents server information is required between the contents server storing the 3D model file and the terminal controlling the 3D printer. When downloading the 3D model file from the contents server, it takes time with large data traffic consumption.

Further, it takes long time to print the reconstructed 3D model file, and when the problem occurs during the 3D printing, it must set up the 3D printer again and perform the 3D printing operation.

Today, the 3D printer typically controls the 3D printer using a PC or a smartphone within the visible distance of the 3D printer. Accordingly, when the user downloads the contents for the 3D printing from the contents server, and performs the 3D printing operation after performing the modeling for the 3D printing, there are inconveniences that the user holding the terminal must stay in the vicinity of the 3D printer for a long time or must periodically visit a place where the 3D printing is performed.

Further, when the user leaves the place where the 3D printing is performed, it is impossible to recognize situations such as the running out of the raw materials, the occurrence of mechanical defects of the 3D printer, etc. which may occur during the process of performing the 3D printing operation.

In addition, when the user controls the 3D printer using the smartphone, the user must download the 3D model file from the smartphone and control the 3D printer. Therefore, it must be capable of handling the large-capacity 3D model file download and modeling, and wireless network costs are incurred. Also, the size of the 3D printing can be limited due to the function of the smartphone.

Therefore, the 3D printing can be controlled by the smartphone, but there is required the development of technology for providing the 3D printing service by interoperation between the service server and the 3D printer.

### PRIOR ART DOCUMENTS

### Patent Documents

(Patent Document) Korean Patent Application Publication No. 10-2016-0146160 (Date of Publication: Dec. 21, 2016, entitled “Remote controller for 3D printing and the managing method using the same”)

### SUMMARY OF THE INVENTION

An object of the present invention is to enable a user to safely perform 3D printing which takes a long time, regardless of time and place.

Furthermore, an object of the present invention is to enable users of a remote place to safely share and use an expensive 3D printer.

Furthermore, an object of the present invention is to provide an environment of a one-to-one collaboration and one-to-many structure collaboration so that a large amount of 3D printing can be simultaneously performed through a plurality of 3D printers.

In order to accomplish the above objects, the present invention provides a method of 3D collaborative printing performed by a 3D collaborative printing system, including: generating, by a user terminal, control information to store the control information in a service server; generating, by the service server, a secure token to transmit the secure token to the user terminal; transmitting, by the user terminal, the secure token to one or more 3D printer; receiving, by the one or more 3D printer, the control information corresponding to the secure token from the service server using the secure token; and performing, by the one or more 3D printer, an operation corresponding to the control information.

In this case, the user terminal may access the service server by using an access token.

In this case, the access token may be generated by the service server, or may be issued by the user terminal based on a predefined protocol with the service server.

In this case, the generating the secure token may transmit the secure token to the user terminal, the secure token generated by the service server using the access token and session information with the user terminal.

In this case, the control information may include at least one of environment information for using a service supported by the service server and contents information corresponding to a service target.

In this case, the performing the operation corresponding to the control information may download contents corresponding to the contents information and may perform 3D printing the downloaded contents corresponding to the environment information.

In this case, the method may further include mapping, by the service server, the control information corresponding to the user terminal to the secure token and storing the control information and the secure token.

Furthermore, an embodiment of the present invention provides a user terminal, including: an access token management unit configured to manage an access token; a control information generation unit configured to generate control information; a server interfacing unit configured to access a service server by using the access token and receive a secure token from the service server; and a printer interfacing unit configured to transmit the secure token to one or more 3D printer for performing, an operation of the control information corresponding to the secure token.

In this case, the access token management unit may receive the access token issued from the service server, or may issue the access token based on a predefined protocol with the service server.

In this case, the server interfacing unit may transmit a service identifier and the access token to the service server, and may receive the secure token corresponding to the service identifier from the service server.

In this case, the printer interfacing unit may transmit the service identifier, the access token and the secure token to the 3D printer, and may receive contents information corresponding to the service identifier from the 3D printer.

Furthermore, an embodiment of the present invention provides a service server, including: a terminal interfacing unit configured to receive an access token and control information from a user terminal and transmit a secure token to the user terminal; a secure token issuing unit configured to generate the secure token to be transmitted to the user terminal based on the access token; and a printer communication unit configured to authenticate an access of one or more 3D printer receiving the secure token from the user terminal and transmit the control information to the authenticated 3D printer.

In this case, the service server may further include a control information management unit for mapping the control information corresponding to the user terminal to the secure token and storing the control information and the secure token.

In this case, the secure token issuing unit may issue the secure token by using the access token and session information with the user terminal.

In this case, the terminal interfacing unit may encrypt the secure token and may transmit the secure token to the user terminal.

In this case, the printer communication unit may perform the authentication for the secure token received from the 3D printer, and may transmit the control information corresponding to the secure token to the 3D printer.

In this case, the service server may further include an access token issuing unit for issuing the access token to be transmitted to the user terminal.

In this case, the printer communication unit may receive a service identifier, the access token and the secure token from the 3D printer.

In this case, the printer communication unit may transmit the service identifier, an order of contents, the contents and message to the 3D printer.

In this case, the terminal interfacing unit may receive the service identifier and the access token from the user terminal, and may transmit the secure token corresponding to the service identifier to the user terminal.

### BRIEF DESCRIPTION OF THE DRAWINGS

FIG. 1 is a diagram schematically showing a configuration of 3D collaborative printing system according to an embodiment of the present invention;

FIG. 2 is a block diagram showing a configuration of a user terminal according to an embodiment of the present invention;

FIG. 3 is a block diagram showing a configuration of a service server providing a 3D collaborative printing service according to an embodiment of the present invention;

FIG. 4 is a flowchart showing a 3D collaborative printing process performed by a 3D collaborative printing system service according to an embodiment of the present invention;

FIG. 5 is a flowchart for explaining a 3D collaborative printing method performed by a 3D collaborative printing system according to an embodiment of the present invention;

FIG. 6 is a flowchart for explaining a process of providing a 3D collaborative printing service according to an OMA GotAPI structure according to an embodiment of the present invention;

FIG. 7 is a diagram schematically showing an architecture diagram of OMA GotAPI according to an embodiment of the present invention;

FIGS. 8 and 9 are diagrams showing a main configuration of a first authentication interface according to an embodiment of the present invention;

FIGS. 10 and 11 are diagrams showing a main configuration of a second authentication interface according to an embodiment of the present invention;

FIGS. 12 and 13 are diagrams showing a main configuration of a third authentication interface according to an embodiment of the present invention; and

FIG. 14 is a block diagram showing a computer system according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

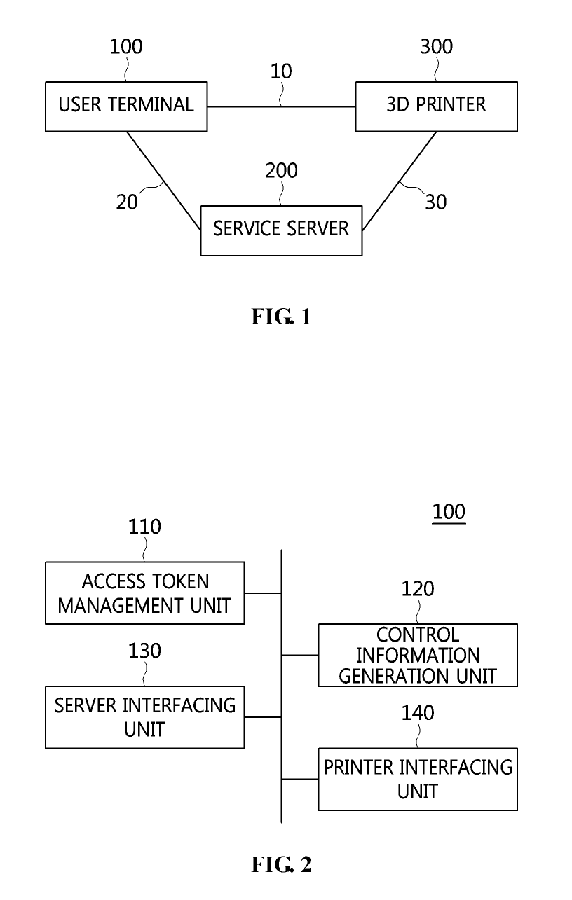

FIG. 1 is a diagram schematically showing a configuration of 3D collaborative printing system according to an embodiment of the present invention.

As shown in FIG. 1, a 3D collaborative printing system includes a user terminal 100, a service server 200 and a 3D printer 300.

The user terminal 100 performs a control of a 3D collaborative printing service and the actual 3D collaborative printing service is performed by interoperation between the external service server 200 and the 3D printer 300. In this case, the 3D printer 300 may access the service server 200 without intervention of the user terminal 100 and may obtain control information (contents and parameter setting information) previously stored by the user terminal 100. Further, the 3D printer 300 may perform a 3D printing operation based on the obtained control information.

In other words, the user terminal 100 may select contents of the service server 200 for using the 3D printing service and may set various parameters for 3D printing the selected contents. Further, the user terminal 100 may transmit a printing command to the 3D printer 300 from a remote location, and the 3D printer 300 accesses the service server 200 so that the 3D printer 300 may obtain control information related to contents and parameter setting information and may perform the 3D printing of the contents corresponding to the parameter setting information.

In this case, the user terminal 100 may access the service server 200 through a first interface 10 and may access the 3D printer 300 through a second interface 20. Further, the 3D printer 300 may access the service server 200 through a third interface 30.

That is, in a multiple terminal environment including one or more user terminal 100 and one or more 3D printer 300, the user terminal 100 such as a smartphone may handle a control function, the control information may be stored in the service server 200, the 3D printer 300 may obtain the control information from the service server 200 by using a secure token received from the user terminal 100, and the collaborative environment performing the 3D printing corresponding to the obtained control information may be provided.

As described above, in the 3D collaborative printing system according to an embodiment of the present invention, the control of the 3D printer 300 may be handled in the user terminal 100 and the process of downloading and modeling of the actual target contents may be handled by the service server 200 corresponding to a cloud service, so that the 3D printer 300 may access the service server 200 without intervention of the user terminal 100 and the 3D printing operation which takes a long time may be safely performed regardless of the location of the user terminal 100.

Although FIG. 1 illustrates only one of the user terminal 100, one of the service server 200 and one of the 3D printer 300, the 3D collaborative printing system, if necessary, may be configured with one or more user terminal 100, one or more service server 200 and one or more 3D printer 300.

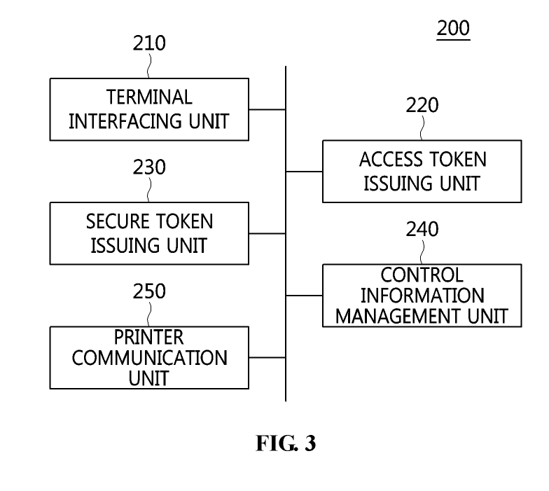

Hereinafter, a configuration of the user terminal and the service server supporting the 3D collaborative printing service according to an embodiment of the present invention will be described in more detail with reference to FIGS. 2 and 3.

FIG. 2 is a block diagram showing a configuration of a user terminal according to an embodiment of the present invention.

As shown in FIG. 2, the user terminal 100 includes an access token management unit 110, a control information generation unit 120, a server interfacing unit 130, and a printer interfacing unit 140.

First, the access token management unit 110 manages an access token. In this case, the access token management unit 110 may receive the access token issued from the service server 200, or may issue the access token based on a predefined protocol with the service server 200.

Further, the control information generation unit 120 generates control information. The control information generation unit 120, through a contents information control UI, may generate the control information by controlling a service supported by the service server 200. Here, the control information may include at least one of environment information for using a service of the service server 200 and a Unified Resource Identifier (URI) for specifying the service target contents.

Next, the server interfacing unit 130 accesses the service server 200 by using the access token and receives the secure token from the service server 200. In this case, the server interfacing unit 130 may perform a communication with the service server 200 through the first interface and may transmit the service identifier and the access token to the service server 200 and may receive the secure token corresponding to the service identifier from the service server 200.

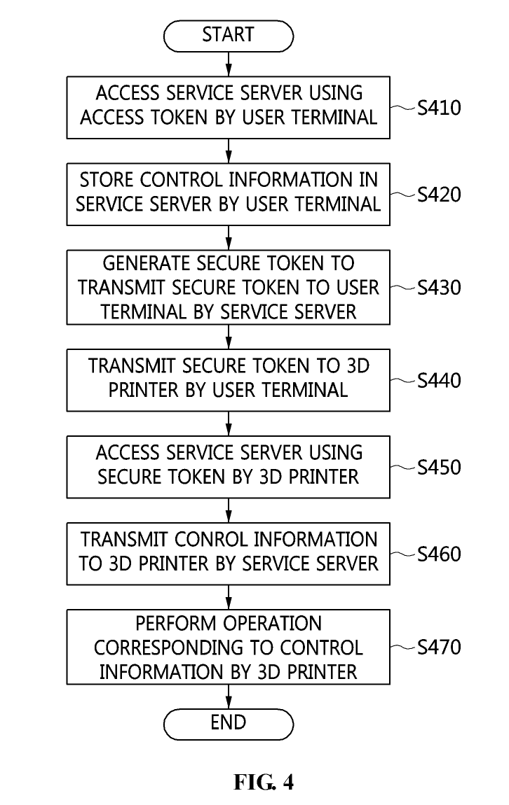

Further, the printer interfacing unit 140 performs a communication through the one or more 3D printer 300 and the second interface. The printer interfacing unit 140 may transmit the secure token to the one or more 3D printer 300 to allow the 3D printer 300 to perform a 3D printing operation using the secure token. The process of the 3D printer 300 performing a 3D printing operation by using the secure token will be described in more detail with reference to FIG. 4.

Finally, the printer interfacing unit 140 may transmit the service identifier, the access token and the secure token to the 3D printer 300 through the second interface and may receive contents information corresponding to the service identifier from the 3D printer 300.

FIG. 3 is a block diagram showing a configuration of a service server providing a 3D collaborative printing service according to an embodiment of the present invention.

As shown in FIG. 3, the service server 200 includes a terminal interfacing unit 210, an access token issuing unit 220, a secure token issuing unit 230, a control information management unit 240 and a printer communication unit 250.

First, the terminal interfacing unit 210 performs a communication through the user terminal 100 and the first interface. The terminal interfacing unit 210 may receive the access token and the control information from the user terminal 100 and may transmit the secure token to the user terminal 100.

In particular, the terminal interfacing unit 210 may receive the service identifier and the access token from the user terminal 100 through the first interface, and may transmit the secure token corresponding to the service identifier to the user terminal 100. Further, the terminal interfacing unit 210 may encrypt the secure token and may transmit the secure token to the user terminal 100.

Further, the access token issuing unit 220 issues the access token to be transmitted to the user terminal 100. Although it is described that the access token issuing unit 220 of the service server 200 issues the access token and transmits the access token to the user terminal 100 for the convenience of description, the present invention is not limited thereto, and the user terminal 100 may issue the access token based on a predefined protocol with the service server 200.

Next, the secure token issuing unit 230 generates the secure token to be transmitted to the user terminal 100 based on the access token corresponding to the user terminal 100. In this case, the secure token issuing unit 230 may generate the secure token by using the access token and session information with the user terminal 100.

The control information management unit 240 maps the control information corresponding to the user terminal 100 to the secure token, and stores and manages the control information and the secure token.

Finally, the printer communication unit 250 performs the communication with the one or more 3D printer 300 through the third interface. The printer communication unit 250 may perform the authentication for an access of the 3D printer 300 which transmits the secure token, and may transmit the control information corresponding to the secure token to the authenticated 3D printer 300.

Further, the printer communication unit 250 may receive the service identifier, the access token and the secure token from the 3D printer 300 through the third interface, and may transmit the service identifier, the order of the contents, the contents and the message to the 3D printer 300.

Hereinafter, the method of the 3D collaborative printing performed by the 3D collaborative printing system according to an embodiment of the present invention will be described in more detail with reference to FIG. 4.

FIG. 4 is a flowchart showing a 3D collaborative printing process performed by a 3D collaborative printing system service according to an embodiment of the present invention.

The 3D collaborative printing system includes the one or more user terminal 100, the one or more service server 200 and the one or more 3D printer 300. The user terminal 100 and the 3D printer 300 may be connected through the first interface, the user terminal 100 and the service server 200 may be connected through the second interface, and the service server 200 and the 3D printer 300 may be connected through the third interface.

First, the user terminal 100 accesses the service server 200 by using the access token at step S410, and stores the control information in the service server 200 at step S420.

The user terminal 100 corresponding to the access token for an access security accesses the service server 200 through the second interface. Here, the access token may be previously issued by the user terminal 100 from the service server 200, or may be issued by a third security module. Further, the access token may be issued by the user terminal 100 based on the predetermined protocol with the service server 200.

Further, the user terminal 100, through a contents information control UI, may generate the control information by controlling the service of the service server 200. Here, the control information may mean environment information for using a service supported by the service server 200, or a contents URI for specifying the contents.

Further, the service server 200 generates the secure token, and transmits the secure token to the user terminal 100 at step S430.

The service server 200 may generate the secure token by using the access token received from the user terminal 100 and the session information with the user terminal 100, and may transmit the generated secure token to the user terminal 100. Here, the session information with the user terminal 100 may be generated by the service server 200.

Further, the service server 200 may store the control information and the secure token in a secure token control information DB by mapping the control information received from the user terminal 100 to the secure token. The secure token may be a unique value in the service server 200, may be non-redundant, and may be encrypted and decrypted by a specific algorithm.

Further, the service server 200 transmits the secure token to the user terminal 100 through the second interface. In this case, the service server 200, to improve the security, may encrypt the secure token and, may transmit the secure token to the user terminal 100.

The user terminal 100 receiving the secure token from the service server 200 transmits the secure token to the 3D printer 300 at step S440, and the 3D printer 300 accesses the service server 200 by using the secure token at step S450.

The user terminal 100 transmits the secure token to the one or more 3D printer 300 through the first interface. In this case, for security, the user terminal 100 may encrypt and transmit the secure token, and the 3D printer 300 receiving the encrypted secure token may further perform the process of decrypting the secure token. Further, the 3D printer 300 receiving the secure token may access the service server 200 through the third interface.

The service server 200 performs the authentication for the secure token received from the 3D printer 300, and transmits the control information to the 3D printer 300 at step S460.

When the authentication for the secure token received from the 3D printer 300 is successful, the service server 200 may obtain the control information corresponding to the secure token from the secure token control information DB and may transmit the control information to the 3D printer 300.

Finally, the 3D printer 300 receiving the control information performs the operation corresponding to the control information at step S470.

The control information may include environment information for using the service of the service server 200 and a URI for specifying the service target contents, and the 3D printer 300 may perform 3D printing the service target contents based on the environment information corresponding to the control information generated by the user terminal 100.

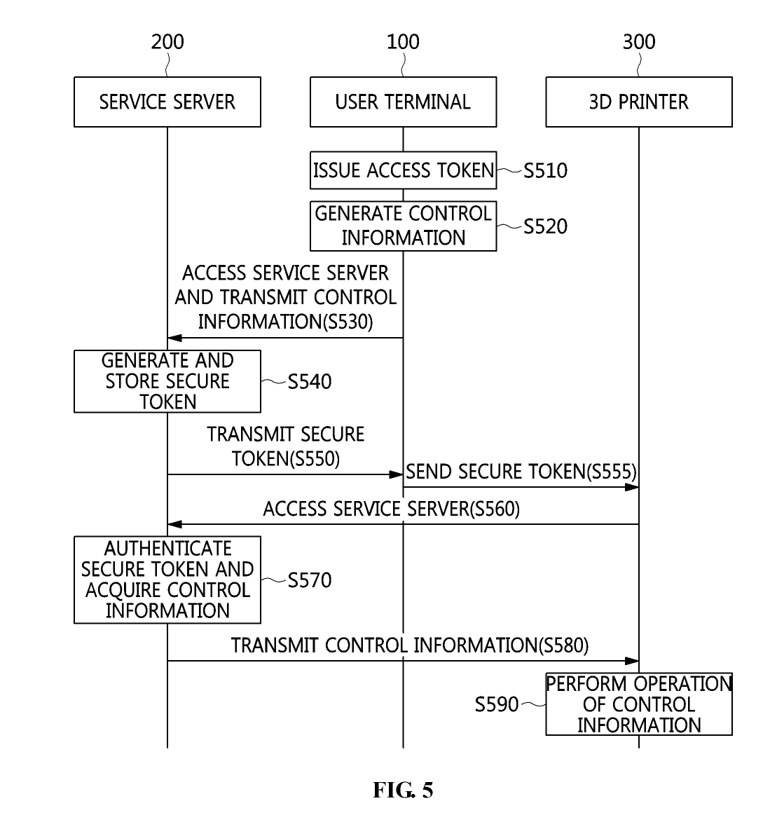

The method of the 3D collaborative printing performed by the 3D collaborative printing system including the user terminal 100, the service server 200 and the 3D printer 300 will be described in more detail with reference to FIG. 5.

FIG. 5 is a flowchart for explaining a 3D collaborative printing method performed by a 3D collaborative printing system according to an embodiment of the present invention.

First, the user terminal 100 issues the access token at step S510 and generates the control information at step S520.

The user terminal 100 may issue the access token by using the predetermined protocol with the service server 200, or may receive the access token from the service server 200 or the third security module.

Further, the user terminal 100 accesses the service server 200 by using the access token, and transmits the control information to the service server 200 at step S530.

The process of the user terminal 100 accessing the service server 200 using the control information and transmitting the control information to the service server 200 is substantially the same as steps S410 and S420 of FIG. 4 so that repeated descriptions will be omitted.

Next, the service server 200 receiving the control information generates and stores the secure token at step S540, and transmits the generated secure token to the user terminal 100 at step S550.

The service server 200 may generate the secure token by using the access token received from the user terminal 100 and the session information with the user terminal 100. Further, the service server 200 may map the control information received from the user terminal 100 to the generated secure token, and may store the control information and the secure token in the secure token control information DB.

The process of the service server 200 generating the secure token and transmitting the secure token to the user terminal 100 is substantially the same as step S430 of FIG. 4 so that repeated descriptions will be omitted.

Further, the user terminal 100 sends the received secure token to the one or more 3D printer 300 at step S555, and the 3D printer 300 accesses the service server 200 by using the secure token at step S560.

The process of the 3D printer 300 receiving the secure token from the user terminal 100 and accessing the service server 200 by using the secure token is substantially the same as steps S440 and S450 of FIG. 4 so that repeated descriptions will be omitted.

The service server 200 performs the authentication for the secure token received from the 3D printer 300 and acquires the control information corresponding to the secure token from the secure token control information DB at step S570. Further, the service server 200 transmits the control information to the 3D printer 300 at step S580 so that the 3D printer 300 may perform the operation corresponding to the control information.

The process of the service server 200 transmitting the control information to the 3D printer 300 is substantially the same as step S460 of FIG. 4 so that repeated descriptions will be omitted.

Finally, the 3D printer 300 receiving the control information performs 3D printing the contents corresponding to the control information at step S590.

The control information received by the 3D printer 300 may include the environment information (ex. parameter setting information) for using the service of the service server 200, and the URI for specifying the service target contents. Further, the 3D printer 300 may perform 3D printing the contents corresponding to the environment information.

Although it describes that the user terminal 100, at step S555, sends the secure token to the single 3D printer 300, and the service server 200, at step S580, transmits the control information to the single 3D printer 300 for the convenience of description, the present invention is not limited thereto, and the user terminal 100, at step S555, may send the secure token to a plurality of the 3D printers, and the service server 200, at step S580, may transmit the control information to a plurality of the 3D printers.

For example, when the user terminal 100 transmits the secure token to the first 3D printer, the second 3D printer and the third 3D printer, the secure token may be the authentication information and may also be the identifier receiving the control information for performing the assigned function by a plurality of the 3D printers.

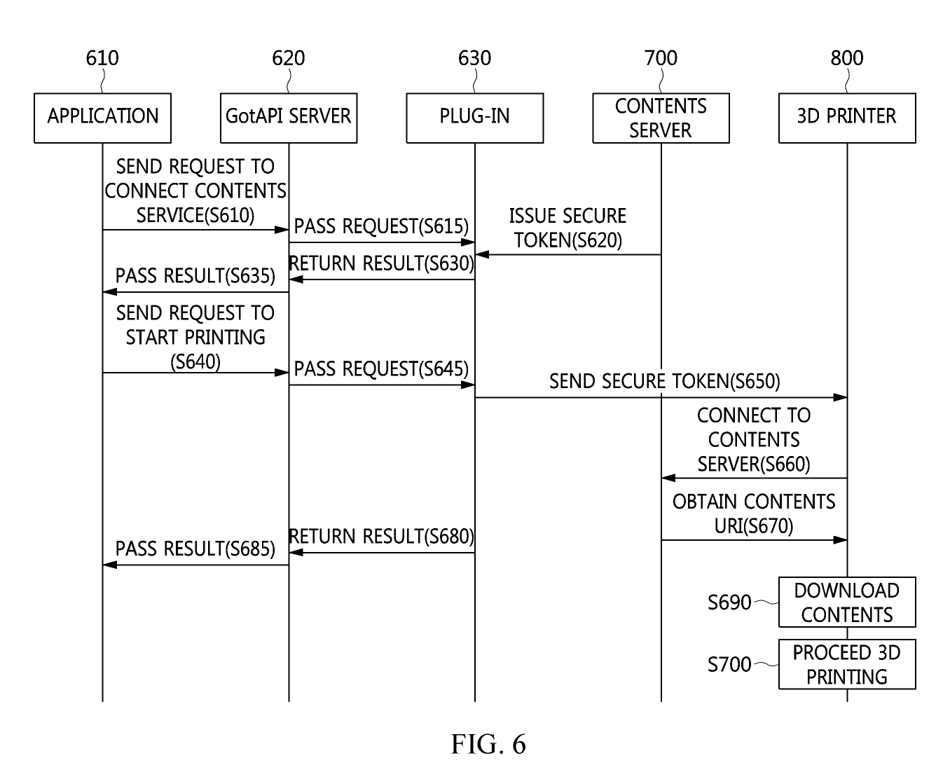

Hereinafter, the process of providing the 3D collaborative printing service according to the OMA GotAPI structure according to an embodiment of the present invention will be described in more detail with reference to FIG. 6.

FIG. 6 is a flowchart for explaining the process of providing the 3D collaborative printing service according to the OMA GotAPI structure according to an embodiment of the present invention.

The Device Web API (DMAPI) defined by international standards such as OMA, etc. has been mainly related to healthcare sensors and devices which are directly connected to the user terminal such as a smartphone. These healthcare sensors and devices may be always directly connected to the user terminal, and the user terminal may directly check the status of the healthcare sensors and devices.

Further, in the OMA GotAPI structure, an application 610 sends a request to connect the contents service to a GotAPI server 620 at step S610, and the GotAPI server 620 passes the request to connect the contents service to an extension plug-in 630 at step S615.

Here, the application 610 may mean a native application, a hybrid application and a web application, and the GotAPI may be connected to the application 610 through a HTTP, a Web Socket, a WebRTC, etc.

Further, the GotAPI passes the control of the application 610 to the extension plug-in 630 through the GotAPI server 620, and the extension plug-in 630 may execute the function by accessing a 3D printer 800 through a Wi-Fi, a Bluetooth, an internet, etc., or may access a cloud server such as a contents server 700.

Referring again to FIG. 6, the extension plug-in 630 may receive the secure token from the contents server 700 corresponding to the service server at step S620, and through the GotAPI server 620 at step S630, may pass a result to the application 610 at step S635.

Further, the application 610 sends a request to start printing to the GotAPI server 620 at step S640, and the GotAPI server 620 passes the request to start printing to the extension plug-in 630 at step S645. Further, the extension plug-in 630 receiving the request to start printing sends the secure token to the 3D printer 800 at step S650.

The extension plug-in 630 installed in the user terminal 100, by accessing the contents server 700 by the 3D printer 800, obtains the control information (contents and parameter setting information) related to the 3D printing which is previously set by the user, and sends the secure token to the 3D printer 800 for performing 3D printing the contents corresponding to the parameter setting information.

The 3D printer 800 receiving the secure token connects to the contents server 700 at step S660, and obtains a contents URI from the contents server 700 at step S670.

The 3D printer 800, by using the secure token received from the extension plug-in 630 of the user terminal 100, may access the contents server 700 corresponding to the service server and may obtain the 3D contents URI for 3D printing from the contents server 700.

Further, the extension plug-in 630 returns the result to the GotAPI server 620 at step S680, and the GotAPI server 620 passes the result to the application 610 at step S685.

Further, the 3D printer 800 obtaining the contents URI downloads the contents corresponding to the contents URI at step S690, and proceeds 3D printing the contents at step S700.

Although it describes that the steps S680 and S685 are performed prior to the steps S690 and S700 for the convenience of description, the present invention is not limited thereto, and the steps S680 and S685 may be performed independently of the steps S690 and S700 which are performed by the 3D printer 800, or may be performed after the steps S690 and S700.

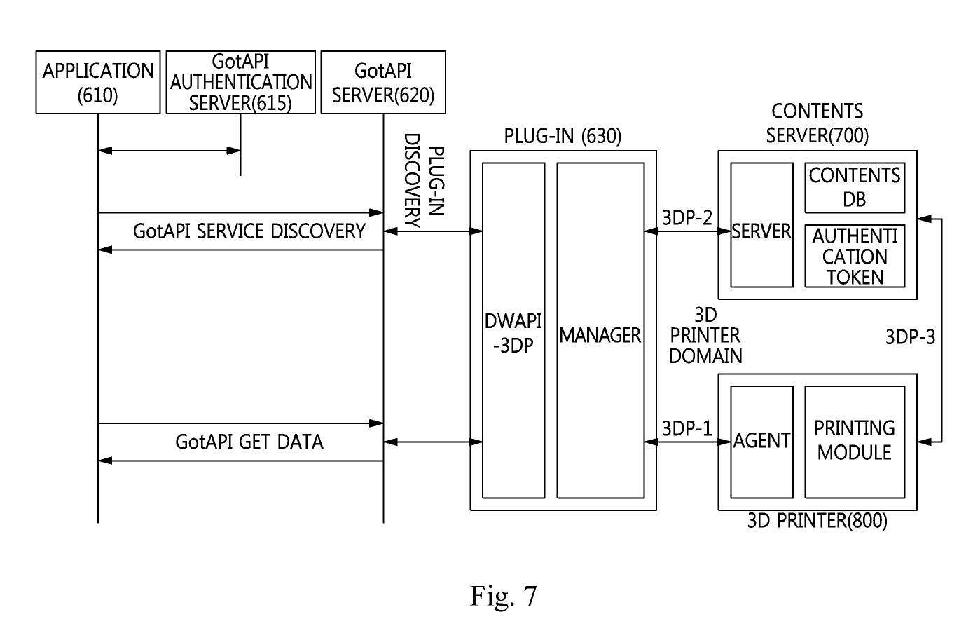

Hereinafter, an architecture diagram of OMA GotAPI and the authentication interface according to an embodiment of the present invention will be described in more detail with reference to FIGS. 7 to 13.

FIG. 7 is a diagram schematically showing the architecture diagram of OMA GotAPI according to an embodiment of the present invention.

As shown in FIG. 7, the GotAPI performs the authentication between the application 610 and the extension plug-in 630 through a GotAPI authentication server 615, and transmits the control of the application to the extension plug-in 630 through the GotAPI server 620.

Further, the first authentication interface (3DP-1) provides interoperation between the extension plug-in 630 installed in the user terminal 100 and the 3D printer 800 corresponding to the external device, the second authentication interface (3DP-2) provides interoperation between the extension plug-in 630 and the contents server 700 corresponding to the external service server, and the third authentication interface (3DP-3) provides interoperation between the 3D printer 800 and the contents server 700.

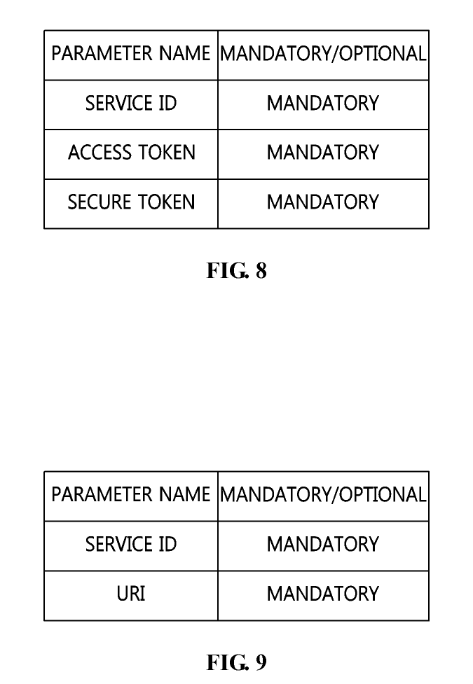

FIGS. 8 and 9 are diagrams showing a main configuration of a first authentication interface according to an embodiment of the present invention.

As shown in FIG. 8, the request parameter of sending secure token corresponding to the first authentication interface may include the service ID, the access token, and the secure token.

Further, the service ID may mean the identifier of the target service and may be available from the Service Discovery API on the GotAPI-1 interface. The access token may be obtained from the GotAPI authentication server through the GotAPI-2 interface, and the secure token may be obtained from the contents server 700 through the second authentication interface (3DP-2).

The response parameter of sending secure token may include the service ID and the contents URI, and the contents URI may be a URI that specify the target contents to be printed, and the URI may be the form such as “file://www.3dpexcont.com/ex.stl”.

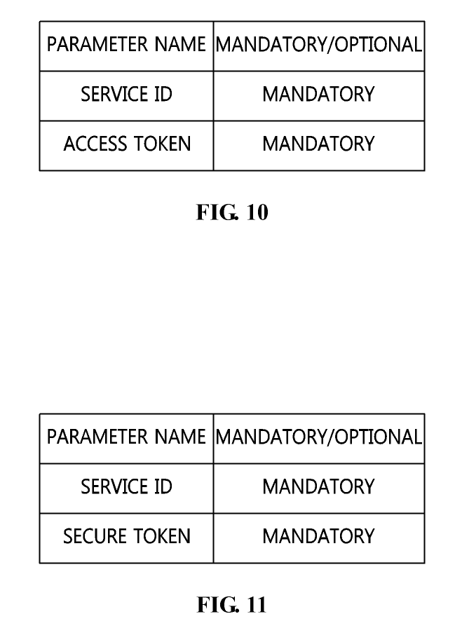

FIGS. 10 and 11 are diagrams showing a main configuration of a second authentication interface according to an embodiment of the present invention.

As shown in FIG. 10, the request parameter of issuing secure token may include the service ID and the access token, and the response parameter of issuing secure token, as shown in FIG. 11, may include the service ID and the secure token. The definition of the service ID, the access token and the secure token is substantially the same as FIGS. 8 and 9 so that repeated descriptions will be omitted.

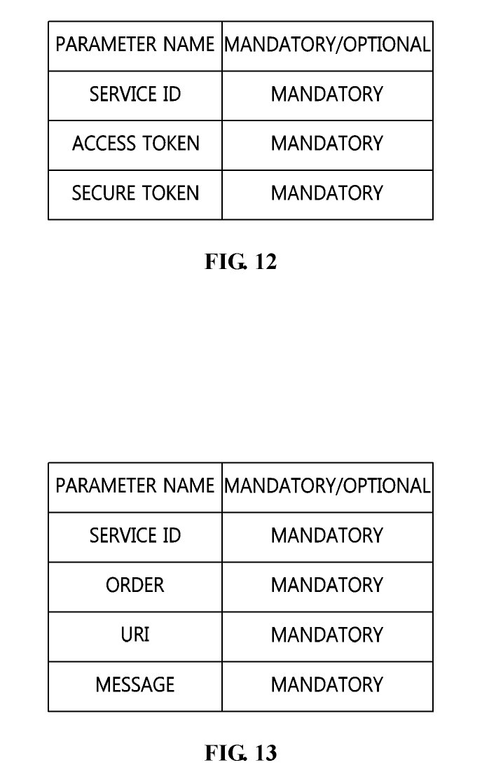

FIGS. 12 and 13 are diagrams showing a main configuration of a third authentication interface according to an embodiment of the present invention.

As shown in FIG. 12, the request parameter of sending secure token corresponding to the third authentication interface may include the service ID, the access token and the secure token. Further, as shown in FIG. 13, the response parameter of sending secure token may include the service ID, the order, the contents URI and the message.

Here, the order may mean the printing order of the target contents, and may have 0 to a maximum integer value. In this case, the 0 may mean the contents is under printing, and the 1 or more integer may mean the number of contents waiting on the print queue before the contents. Further, the message may mean the status of the target contents, and may indicate “Good Start” or “Waiting”.

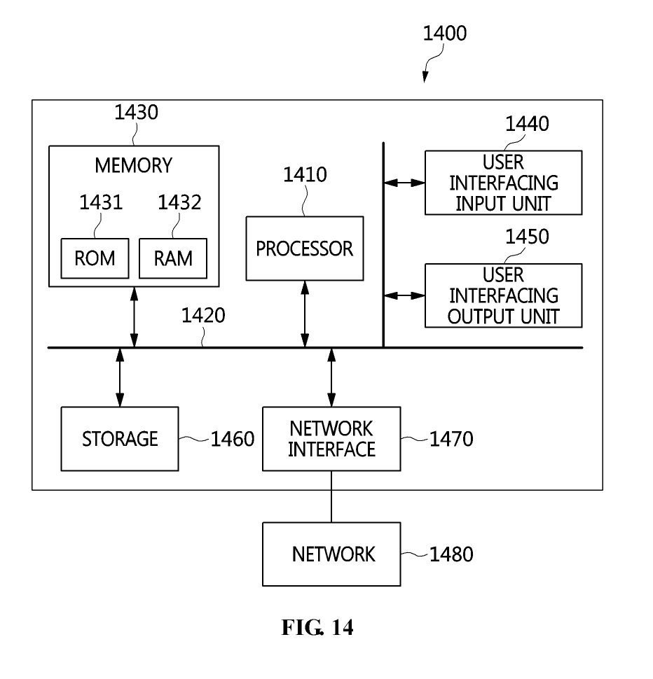

FIG. 14 is a block diagram showing a computer system according to an embodiment of the present invention.

Referring to FIG. 14, the embodiment of the present invention may be implemented in a computer system 1400, such as a computer-readable storage medium. As shown in FIG. 14, the computer system 1400 may include one or more processors 1410, a memory 1430, a user interfacing input unit 1440, a user interfacing output unit 1450, and a storage 1460, which communicate with each other through a bus 1420. The computer system 1400 may further include a network interface 1470 connected to a network 1480. Each processor 1410 may be a Central Processing Unit (CPU) or a semiconductor device for executing processing instructions stored in the memory 1430 or the storage 1460. Each of the memory 1430 and the storage 1460 may be any of various types of volatile or nonvolatile storage media. For example, the memory may include Read Only Memory (ROM) 1431 or Random Access Memory (RAM) 1432.

Accordingly, the embodiments of the present invention may be implemented as a method using a computer or may be implemented as a nonvolatile recording medium. When the computer readable commands are executed by the processor, the computer readable commands may be capable of executing the method according to at least one aspect of the present invention.

According to the present invention, a user can safely perform 3D printing which takes a long time, regardless of time and place.

Furthermore, according to the present invention, users of a remote place can safely share and use an expensive 3D printer.

Furthermore, according to the present invention, it provides an environment of a one-to-one collaboration and one-to-many structure collaboration so that a large amount of 3D printing can be simultaneously performed through a plurality of 3D printers.

As described above, in the service server, the user terminal and the method of 3D collaborative printing for providing the 3D collaborative printing service according to the present invention, the configurations and schemes in the above-described embodiments are not limitedly applied, and some or all of the above embodiments can be selectively combined and configured so that various modifications are possible.

What is claimed is:

1. A method of 3D collaborative printing performed by a 3D collaborative printing system, comprising:
generating, by a user terminal, control information to store the control information in a service server;
generating, by the service server, a secure token to transmit the secure token to the user terminal;
transmitting, by the user terminal, the secure token to one or more 3D printer;
receiving, by the one or more 3D printer, the control information corresponding to the secure token from the service server using the secure token; and
performing, by the one or more 3D printer, an operation corresponding to the control information.

2. The method of claim 1, wherein the user terminal accesses the service server by using an access token.

3. The method of claim 2, wherein the access token is generated by the service server, or is issued by the user terminal based on a predefined protocol with the service server.

4. The method of claim 2, wherein the generating the secure token transmits the secure token to the user terminal, the secure token generated by the service server using the access token and session information with the user terminal.

5. The method of claim 1, wherein the control information includes at least one of environment information for using a service supported by the service server and contents information corresponding to a service target.

6. The method of claim 5, wherein the performing the operation corresponding to the control information downloads contents corresponding to the contents information and performs 3D printing the downloaded contents corresponding to the environment information.

7. The method of claim 1, further comprising:
mapping, by the service server, the control information corresponding to the user terminal to the secure token and storing the control information and the secure token.

8. A user terminal, comprising:
an access token management unit configured to manage an access token;
a control information generation unit configured to generate control information;
a server interfacing unit configured to access a service server by using the access token and receive a secure token from the service server; and
a printer interfacing unit configured to transmit the secure token to one or more 3D printer for performing, an operation of the control information corresponding to the secure token.

9. The user terminal of claim 8, wherein the access token management unit receives the access token issued from the service server, or issues the access token based on a predefined protocol with the service server.

10. The user terminal of claim 8, wherein the server interfacing unit transmits a service identifier and the access token to the service server, and receives the secure token corresponding to the service identifier from the service server.

11. The user terminal of claim 8, wherein the printer interfacing unit transmits the service identifier, the access token and the secure token to the 3D printer, and receives contents information corresponding to the service identifier from the 3D printer.

12. A service server, comprising:
a terminal interfacing unit configured to receive an access token and control information from a user terminal and transmit a secure token to the user terminal;
a secure token issuing unit configured to generate the secure token to be transmitted to the user terminal based on the access token; and
a printer communication unit configured to authenticate an access of one or more 3D printer receiving the secure token from the user terminal and transmit the control information to the authenticated 3D printer.

13. The service server of claim 12, further comprising:
a control information management unit for mapping the control information corresponding to the user terminal to the secure token and storing the control information and the secure token.

14. The service server of claim 12, wherein the secure token issuing unit issues the secure token by using the access token and session information with the user terminal.

15. The service server of claim 14, wherein the terminal interfacing unit encrypts the secure token and transmits the secure token to the user terminal.

16. The service server of claim 12, wherein the printer communication unit performs the authentication for the secure token received from the 3D printer, and transmits the control information corresponding to the secure token to the 3D printer.

17. The service server of claim 12, further comprising:
an access token issuing unit for issuing the access token to be transmitted to the user terminal.

18. The service server of claim 12, wherein the printer communication unit receives a service identifier, the access token and the secure token from the 3D printer.

19. The service server of claim 18, wherein the printer communication unit transmits the service identifier, an order of contents, the contents and message to the 3D printer.

20. The service server of claim 12, wherein the terminal interfacing unit receives the service identifier and the access token from the user terminal, and transmits the secure token corresponding to the service identifier to the user terminal.
